(19) United States
(12) Patent Application Publication
(10) Pub. No.: US 2026/0171562 A1
(43) Pub. Date: Jun. 18, 2026

(54) COVER PLATE MANUFACTURING METHOD AND BATTERY TOP COVER

(71) Applicant: SHENZHEN EVERWIN PRECISION TECHNOLOGY CO., LTD., SHENZHEN (CN)

(72) Inventors: GANG TIAN, SHENZHEN (CN); LIDONG WANG, SHENZHEN (CN); YAYONG LI, SHENZHEN (CN); QIUWEN DU, SHENZHEN (CN); XIAOLONG LIU, SHENZHEN (CN); CHAOBING HUANG, SHENZHEN (CN)

(21) Appl. No.: 19/531,673

(22) Filed: Feb. 6, 2026

Related U.S. Application Data
(63) Continuation of application No. PCT/CN2024/103643, filed on Jul. 4, 2024.

(30) Foreign Application Priority Data
Jul. 5, 2023 (CN) 202310821426.2
Jul. 5, 2023 (CN) 202310831484.3

(51) Int. Cl. H01M 50/15; H01M 50/188; H01M 50/55; H01M 50/567

(52) U.S. Cl. CPC H01M 50/15; H01M 50/188; H01M 50/55; H01M 50/567

(57) ABSTRACT

A cover plate manufacturing method and a battery top cover are provided. The cover plate manufacturing method includes following steps: providing a metal sheet, and punching the metal sheet to form punched holes; flanging a portion of the metal sheet on a periphery of each of the punched holes to form a sidewall extending upward; shaping and flattening each sidewall to enable each sidewall to reach a predetermined state; and splitting a material of each sidewall to form a horizontal bottom wall and form cover plates with terminal holes.

### TECHNICAL FIELD

The present disclosure relates to a field of power batteries, and in particular to a cover plate manufacturing method and a battery top cover.

### BACKGROUND

Battery technology is widely used in electric motorcycles, creating significant economic benefits for society. A promotion of electric motorcycles is environmentally friendly, reducing carbon emissions. The most important performance characteristics of automotive batteries comprise safety, high energy density, and impact resistance. The automotive batteries are a type of power batteries. The power batteries are consists of battery cells. The battery cells are connected in series and parallel to form a powerful automotive battery pack. Each battery cell comprises a battery casing, a cell encapsulated within the battery casing, electrolyte, and a top cover sealing the battery casing. The battery cells come in various forms. The most commonly used battery cells on the market comprise cylindrical batteries, prismatic batteries, and blade batteries. Although the battery cells have diverse shapes, their underlying principles are consistent. Namely, each battery cell comprises components such as the battery casing and the top cover.

A CN patent application No. CN 201911418867.8 discloses a top cover of a power battery. The top cover comprises a cover plate, terminals, and overmolded parts. Each of the overmolded parts is disposed around an outer periphery of a corresponding terminal. The cover plate comprises terminal holes formed therein. Each of the terminal holes comprises a lower step and a vertical wall that is not initially vertical. Each of the terminals comprises a raised ring. Each of the overmolded parts extends to a periphery of a lower surface of a corresponding raised ring. A bottom edge of each raised ring contacts a corresponding lower step through a corresponding overmolded part, which covers an upper surface of the raised ring. After the terminals are inserted into the terminal holes, an upper side of each vertical wall is riveted to form a flange that limits the upper surface of a corresponding raised ring, thereby fixing the terminals. The CN application simplifies a product structure, but a manufacturing method of the terminal holes of the cover plate is difficult, and the overmolded parts and the terminals are molded in-mold, resulting in high injection molding costs. Furthermore, the overmolded parts must use flexible materials such as silicone to achieve a sealing effect. That is, the upper and lower sides of each terminal are made of flexible materials, which easily lead to stability problems and high material costs. In addition, each of overmolded parts and the corresponding terminal are integrally molded, resulting in poor versatility.

### SUMMARY

Therefore, it is necessary to provide a cover plate manufacturing method and a battery top cover, which achieves unconventional terminal holes of a cover plate through a punching process.

In a first aspect, the present disclosure provides a cover plate manufacturing method. The cover plate manufacturing method comprises following steps:
S101: providing a metal sheet, and punching the metal sheet to form punched holes;
S102: flanging a portion of the metal sheet on a periphery of each of the punched holes to form a sidewall extending upward;
S103: shaping and flattening each sidewall to enable each sidewall to reach a predetermined state; and
S104: splitting a material of each sidewall to form a horizontal bottom wall and form cover plates with terminal holes.

The material forming an inner wall of each sidewall is extruded in a thickness direction to form the horizontal bottom wall.

In a second aspect, the present disclosure provides a cover plate manufacturing method. The cover plate manufacturing method comprises following steps:
S201: providing a metal sheet, extruding predetermined positions of the metal sheet to thin the predetermined positions and force excess metal from each of the predetermined positions to flow upward, so as to simultaneously form a sidewall and a bottom wall in each of the predetermined positions;
S202: shaping each bottom wall and each sidewall; and
S203: cutting off a central portion of each bottom wall to form a punched hole and finally obtaining cover plates with terminal holes.

To solve technical solutions in the prior art, the present disclosure further provides a battery top cover. The battery top cover comprises a cover plate formed by cover plate manufacturing method described above and at least one terminal assembly fixed in the cover plate. The at least one terminal assembly comprises a terminal, an upper shell covering an upper surface of the terminal, and a sealing piece attached to a lower surface of the terminal. The sealing piece is clamped between the bottom wall of at least one terminal hole and the lower surface of the terminal, and the sidewall of the at least one terminal hole is bent inward to press against the upper shell, so as to apply a downward pressure to deform the sealing piece for sealing a battery.

In the cover plate manufacturing method and the battery top cover of the present disclosure, the terminal holes on the cover plate are formed by the punching process. Each sidewall is formed by first flanging the metal sheet, and then the inner wall of each sidewall is extruded to form the corresponding bottom wall. Each sidewall and each bottom wall are formed by punching process with low cost, which reduces the cost of products manufactured by conventional welding ring process.

### BRIEF DESCRIPTION OF DRAWINGS

FIG. 1 is a perspective schematic diagram of a battery top cover according to a first embodiment of the present disclosure.

FIG. 2 is an exploded perspective schematic diagram of the battery top cover according to the first embodiment of the present disclosure.

FIG. 3 is a cross-sectional schematic diagram of the battery top cover taken along a line C-C shown in FIG. 2.

FIG. 4 is an exploded perspective schematic diagram of a terminal assembly according to the first embodiment of the present disclosure.

FIG. 5 is another perspective schematic diagram of the terminal assembly according to the first embodiment of the present disclosure.

FIG. 6 is an exploded schematic diagram of the terminal assembly according to the first embodiment of the present disclosure.

FIG. 7 is another schematic diagram of the terminal assembly according to the first embodiment of the present disclosure.

FIG. 8 is a cross-sectional schematic diagram of the terminal assembly taken along a line D-D shown in FIG. 6.

FIG. 9 is a cross-sectional schematic diagram of the terminal assembly taken along a dashed line J-J shown in FIG. 4.

FIG. 10 is a cross-sectional schematic diagram of the battery top cover taken along a dashed line A-A shown in FIG. 1.

FIG. 11 is a cross-sectional schematic diagram of the battery top cover taken along a dashed line B-B shown in FIG. 1.

FIG. 12 is an exploded perspective schematic diagram of the battery top cover according to a second embodiment of the present disclosure.

FIG. 13 is an exploded perspective schematic diagram of the battery top cover according to a third embodiment of the present disclosure.

FIG. 14 is a cross-sectional schematic diagram of the battery top cover taken along a dashed line X-X shown in FIG. 13.

FIG. 15 is a cross-sectional schematic diagram of the battery top cover according to the third embodiment of the present disclosure.

FIG. 16 is an exploded perspective schematic diagram of the battery top cover according to a fourth embodiment of the present disclosure.

FIG. 17 is a cross-sectional schematic diagram of the battery top cover taken along a dashed line Y-Y shown in FIG. 16.

FIG. 18 is a cross-sectional schematic diagram of the battery top cover according to the fourth embodiment of the present disclosure.

FIG. 19 is a schematic diagram showing changes in a metal sheet during a process of a cover plate manufacturing method according to a fifth embodiment of the present disclosure.

FIG. 20 is a schematic diagram showing changes in the metal sheet during the process of the cover plate manufacturing method by a punching die according to the fifth embodiment of the present disclosure.

FIG. 21 is a cross-sectional schematic diagram of a structure taken along a dashed line E-E shown in FIG. 19.

FIG. 22 is a cross-sectional schematic diagram of a structure taken along a dashed line F-F shown in FIG. 20.

FIG. 23 is a flow chart of the cover plate manufacturing method according to the fifth embodiment of the present disclosure.

FIG. 24 is a schematic diagram showing changes in the metal sheet during the process of the cover plate manufacturing method according to a sixth embodiment of the present disclosure.

FIG. 25 is a schematic diagram showing changes in the metal sheet during the process of the cover plate manufacturing method by the punching die according to the sixth embodiment of the present disclosure.

FIG. 26 is a cross-sectional schematic diagram of a structure taken along a dashed line G-G shown in FIG. 24.

FIG. 27 is a cross-sectional schematic diagram of a structure taken along a dashed line H-H shown in FIG. 25.

FIG. 28 is a flow chart of the cover plate manufacturing method according to the sixth embodiment of the present disclosure.

### DETAILED DESCRIPTION

In the present disclosure, as shown in FIG. 1, an X direction is defined as a horizontal direction, a Y direction is defined as a vertical direction, and a Z direction is defined as a direction (top) perpendicular to the X direction and the Y direction.

### Embodiment 1

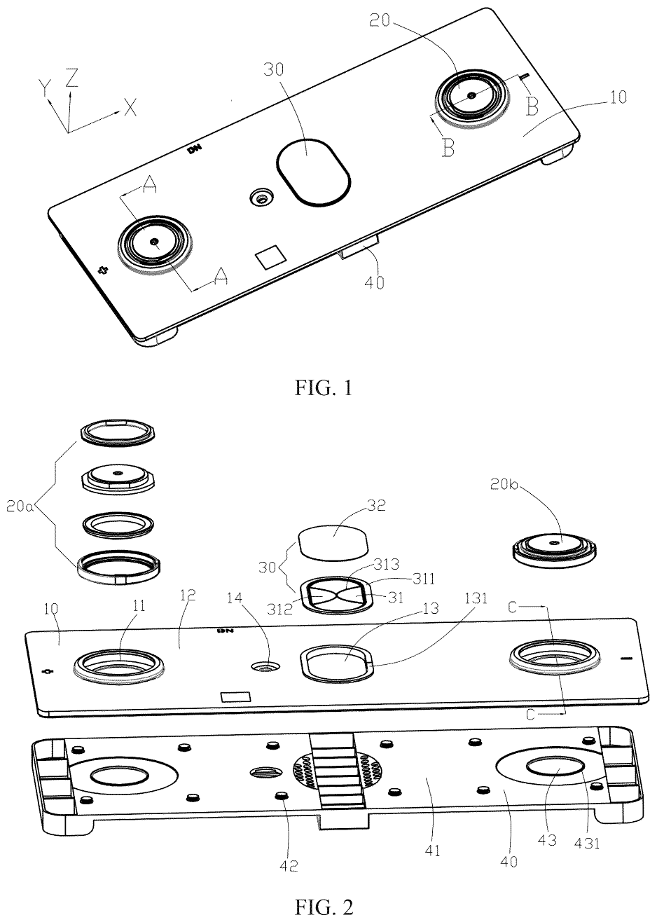

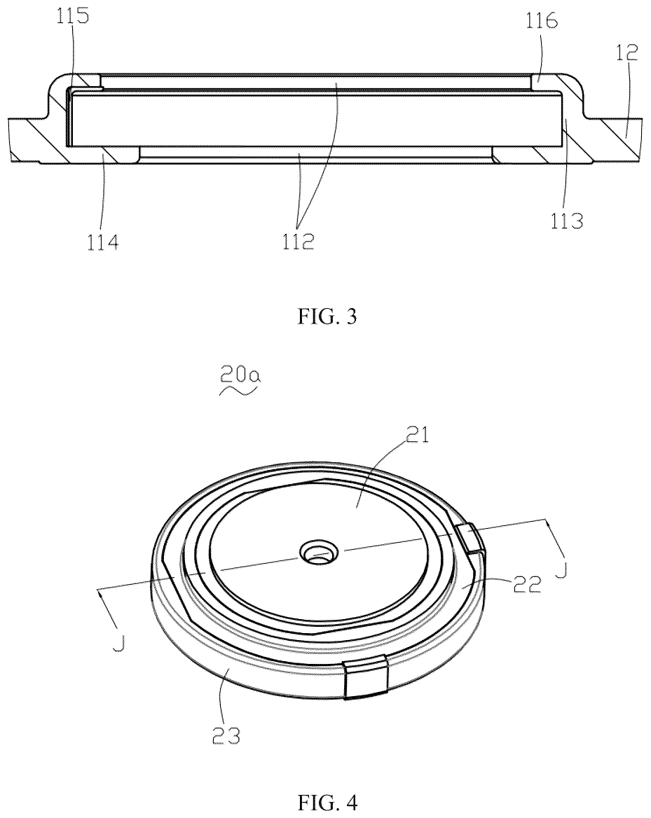

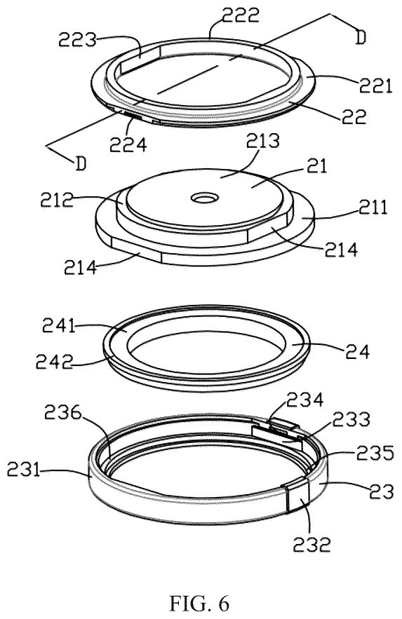

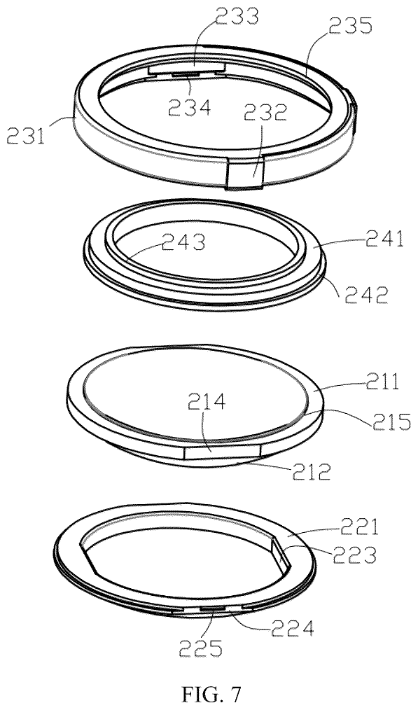

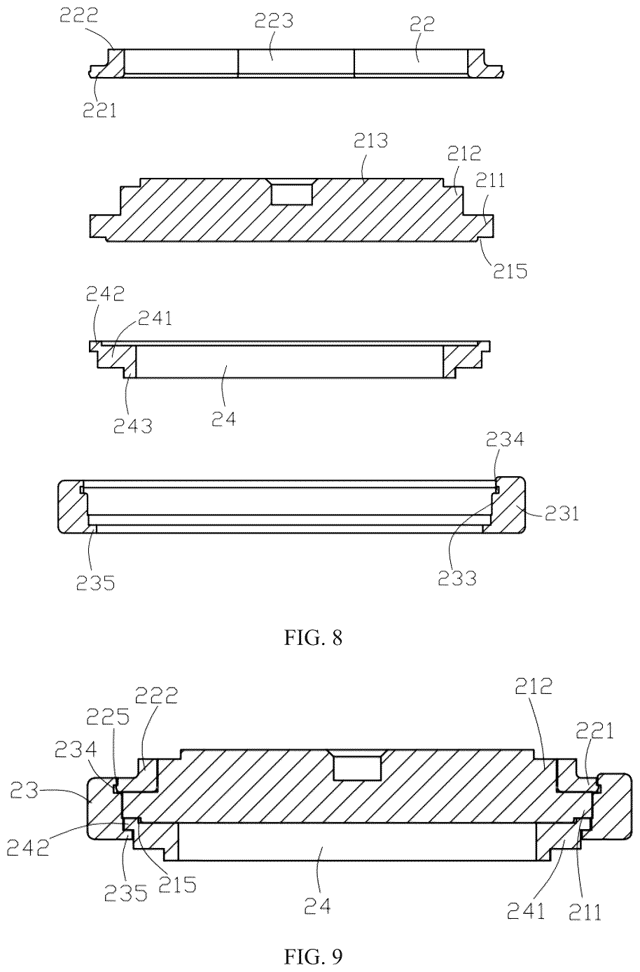

FIGS. 1-11 are schematic diagrams of a terminal assembly and a battery top cover of Embodiment 1.

As shown in FIGS. 1-3, the battery top cover of Embodiment 1 comprises a cover plate 10, terminal assemblies 20, an explosion-proof assembly 30, and an insulating plate 40 fixed to a lower side of the cover plate 10. The cover plate 10 comprises terminal holes 11 and an explosion-proof opening 13. The terminal assemblies 20 are respectively inserted into the terminal hole 11. The explosion-proof assembly 30 is welded to the explosion-proof opening 13.

The cover plate comprises a plate body 12. The terminal holes 11 and the explosion-proof opening 13 penetrate the plate body in the Z direction. A liquid injection port 14 penetrating the plate body 10 in the Z direction is formed on the plate body 12.

Each of the terminal holes 11 comprises a punched hole 112 extending in the Z direction, a bottom wall 114 extending from the plate body 12 along the punched hole, a sidewall 113 extending upward from the plate body 12 along a periphery of the bottom wall 114, and a flange 116. Taking one of the terminal holes 11T as an example, the flange 116 is bent relative to the sidewall 13 and extends from a top portion of the sidewall 113. The flange 116 is disposed above the bottom wall 114. At least one anti-rotation groove 115 is formed on an inner surface of the sidewall 113. A thickness of the bottom wall 114 is not greater than half a thickness of the plate body 12. A bottom surface of the bottom wall 114 protrudes downward from a bottom surface of the plate body 12. The sidewall 113 extends upward from an upper surface of the plate body 12 and is riveted radially inward at a top portion thereof to form the flange 116 disposed above the bottom wall 114. A space formed between the bottom wall 114 and the flange 116 is configured to install and fix a corresponding terminal assembly 20. An inner diameter of a lower portion of the punched hole 112 at the bottom wall 114 is less than an inner diameter of an upper portion of the punched hole 112 at the flange 116. A portion of the plate body 12 disposed on an upper side of the bottom wall 114 forms part of the sidewall 113.

A periphery of the explosion-proof opening 13 protrudes upward to form a raised edge 131, which is a non-planar structure. The explosion-proof assembly 30 comprises an explosion-proof sheet 31 and a protective cover 32. The explosion-proof sheet 31 comprises a welded edge 311, an explosion-proof area 312 formed within the welded edge 311, and grooves 313 formed on the explosion-proof area 312. A thickness of the explosion-proof area 312 is less than a thickness of the welded edge 311. The grooves 313 are formed on the explosion-proof area 312 in a certain pattern so that the explosion-proof area 312 bursts open to release pressure when subjected to a predetermined pressure. The explosion-proof sheet 31 is welded to a bottom edge of the explosion-proof opening 13 via the welding edge 311. The protective cover 32 is affixed to the raised edge 131 of the explosion-proof opening 13, and the non-planar structure of the raised edge 131 allows the explosion-proof opening 13 covered by the protective cover 32 to communicate with an outside. The protective cover 32 is a protective film.

The insulating plate 40 comprises an insulating plate body 41 covering a lower surface of the plate body 12, hot-melt pillars 42 protruding upward from a top portion of the insulating plate body 41, and connecting holes 43 corresponding to the terminal holes 11. An edge of each of the connecting holes 43 protrudes upward to form an annular boss 431. Blind holes (not shown) one-to-one corresponding to the hot-melt pillars 42 are formed on a lower surface of the plate body 12. The insulating plate 40 is fixed to the plate body 10 by respectively inserting the hot-melt pillars 42 into the blind holes and hot-melting the hot-melt pillars 42 to the blind holes

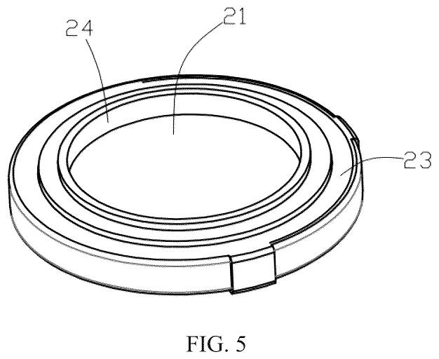

As shown in FIGS. 4-9, the present disclosure takes one of the terminal assemblies as an example to illustrate a structure of each of the terminal assemblies 20 in Embodiment 1.

The terminal assembly 20 of Embodiment 1 comprises a lower shell 23, an upper shell 22, a terminal 21 and a sealing piece 24. The terminal 21 and the sealing piece 24 are disposed between the lower shell 23 and the upper shell 22. The sealing piece 24 is attached to a lower surface of the terminal 21.

The terminal 21 comprises a fixing ring 211, a step portion 212 protruding upward from a central portion of the fixing ring 211, and a connecting portion 213 protruding upward from the step portion 212. The terminal 21 has a segmented cylindrical structure. An outer diameter of the fixing ring 211 is greater than an outer diameter of the step portion 212. The outer diameter of the step portion 212 is greater than an outer diameter of the connecting portion 213. A bottom surface of the fixing ring 211 protrudes downward from a middle portion thereof, so as to form an engaging groove 215 disposed around a periphery of the middle portion of the bottom surface of the fixing ring 211.

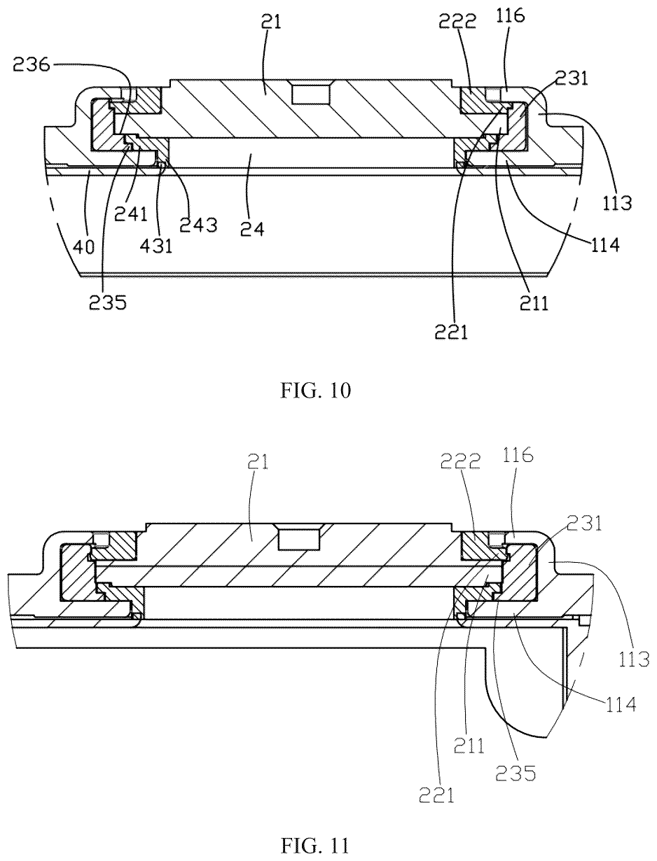

The terminal assemblies 20 comprise a positive terminal assembly and a negative terminal assembly. FIG. 10 is a cross-sectional schematic diagram of the positive terminal assembly, and FIG. 11 is a cross-sectional schematic diagram of the negative terminal assembly. A positive terminal 21 is made of aluminum, while a negative terminal 21 is made of a copper-aluminum composite material. That is, a bottom layer of the negative terminal 21 is made of copper, and a top layer of the negative terminal 21 is made of aluminum. The bottom layer and the top layer of the negative terminal 21 are fixed together by pressing or other methods. In one embodiment, when the terminal 21 of one of the terminal assemblies 20 is the negative terminal, the fixing ring 211 thereof comprises a copper layer and an aluminum layer.

Taking one of the terminal assemblies 20 as an example, the sealing piece 24 comprises a clamping ring 241, an extension cylinder 24, and a limiting raised rim 242. The clamping ring 241 is attached to an outer edge of a lower surface of the fixing ring 211. The extension cylinder 243 integrally extends downward from an inner edge of the clamping ring 241. The limiting raised rim 242 protrudes upward from an outer edge of the clamping ring 241. The sealing piece 24 is made of fluororubber to improve heat resistance and corrosion resistance.

The lower shell 23 comprises a ring body 231, an inner ring 235, and at least one anti-rotation block 232. The inner ring 235 extends from a bottom portion of the ring body 231 towards a center of the ring body 231. The at least one anti-rotation block 232 protrudes from an outer periphery of the ring body 231. At least one anti-rotation flat surface 233 is formed on an inner surface of the ring body 231, and the inner surface of the ring body 231 is an arc surface. The at least one anti-rotation flat surface 233 protrudes from the arc surface of the ring body to form a flat structure. A snapping mating structure 234 is disposed above an upper side of the at least one anti-rotation flat surface 233. The snapping mating structure 234 is either a snapping groove or a snapping block. A limiting step 236 is disposed on the inner surface of the ring body 231 and is disposed above the inner ring 235. An end portion of the fixing ring 211 of the terminal 21 is limited on the limiting step 236 to differentiate a positions of the sealing piece 24 and a position of the terminal 21, preventing excessive compression of the sealing piece 24 during riveting and pressing of the terminal assembly 20, thus protecting the sealing piece 24.

The upper shell 22 comprises a covering body 221 and an isolation protrusion 222. The covering body 221 covers an upper surface of the fixing ring 211 of the terminal 21. The isolation protrusion 222 protrudes upward from an inner edge of the covering body 221. An upper surface of the isolation protrusion 222 is not lower than a surface of the step portion 212 of the terminal 21. Optionally, the upper surface of the isolation protrusion 222 is flush with the surface of the step portion 212 of the terminal 21. At least one anti-rotation mating surface 223 is formed on an inner surface of the upper shell 22. At least one anti-rotation surface 224 corresponding to the at least one anti-rotation surface 233 of the lower shell 23 is formed on an outer edge of the covering body 221. The at least one anti-rotation surface 224 of the covering body 221 is matched with the at least one anti-rotation surface 233 of the lower shell 23 to prevent rotation between the upper shell and the lower shell. A snapping structure 225 is disposed on the at least one anti-rotation surface 224 of the covering body 221. The snapping structure is a hook or a snapping groove. The snapping structure 225 is engaged with the snapping mating structure 234 of the lower shell 23 to achieve pre-fixation of the lower shell 23 and the upper shell 22.

In one embodiment, the upper shell 22 further comprises an extended covering portion (not shown) that protrudes inward from the isolation protrusion 222 to cover the step portion 212.

Each of the terminal assemblies 20 of Embodiment 1 is pre-assembled as a whole before being inserted into a corresponding terminal hole 11 of the cover plate 10.

Specifically, taking one of the terminal assemblies 20 as an example, the sealing piece 24 is first inserted into the lower shell 23 from a top portion of the lower shell 23, with the outer edge of the clamping ring 241 of the sealing piece 24 positioned on the inner ring 235. Then, the terminal 21 is inserted into the lower shell 23 from the top portion of the lower shell 23, with the lower surface of the fixing ring 211 of the terminal 21 abutting against an upper surface of the clamping ring 241 of the sealing piece 24. The engaging groove 215 is radially engaged with the limiting raised rim 242 of the sealing piece 24 to prevent the sealing piece 24 from deforming and slipping inward. Alternatively, the sealing element 24 is first attached to the lower surface of the terminal 21 before being installed into the lower shell 23, preventing displacement and deformation of the sealing element 24.

Finally, the upper shell 22 is pressed into the lower shell 23. At this time, the covering body 221 covers the upper surface of the fixing ring 211, and the snapping structure 225 of the upper shell 22 is snapped with the snapping mating structure 235 of the lower shell 23.

After the terminal assembly 20 is assembled, at least one anti-rotation flat surface 214 on the fixing ring 211 of the terminal 21 is matched with the at least one anti-rotation mating surface 223 on the lower shell 23 to prevent the terminal 21 from rotating within the lower shell 23. The at least one anti-rotation flat surface 214 outside the step portion 212 of the terminal 21 is matched with the at least one anti-rotation mating surface 223 of the upper shell 22 to prevent rotation between the upper shell 22 and the terminal 21. The at least one anti-rotation flat surface 224 of the covering body 221 of the upper shell 22 is matched with the at least one anti-rotation surface 233 of the lower shell 23 to prevent rotation between the lower shell 23 and the upper shell 22.

The upper shell 22 is made of conductive plastic material, such as conductive PPS, while the lower shell 23 is made of insulating plastic material. A resistance of the conductive plastic material of the upper shell 22 is between 1 and 10,000 ohms. By using the conductive plastic material, the upper shell 22 effectively reduces a potential difference between the cover plate 10 and the terminal 21, avoiding electro-corrosion of the cover plate 10 and the terminal, thereby improving the service life of the terminal 21 and the cover plate 10. A price of the conductive plastic material is two to three times that of the insulating plastic material. In the embodiment, a shell is divided into an upper shell 22 and a lower shell 23. The upper shell 22, which serves a covering function, has a significantly reduced volume and material usage. While the lower shell 23, which serves an accommodating function, has a relatively larger volume and material usage. Compared to conventional solutions where the shell as a whole is made of the conductive plastic material, the upper shell and the lower shell significantly reduce material costs. The upper shell 22 and the lower shell 23, compared to the conventional solutions where the shell as a whole is made of the conductive plastic materials, save 60%-70% on conductive plastic material costs, thereby effectively enhancing market competitiveness of the terminal assembly 20.

Furthermore, compared to a conventional terminal, the terminal 21 in the embodiment does not need to protrude downwards on a lower side, greatly reducing a thickness of the terminal 21, thereby reducing material costs of the terminal 21 by 55%-70%. Furthermore, the terminal 21 has a simple structure and is able to be manufactured by a punching process, eliminating the need for costly CNC machining, thereby further reducing the manufacturing costs. The terminal 21 further improves space utilization and increases an energy density per unit volume. In the embodiment, the upper shell 22, the lower shell 23, and the sealing element 24 are independently injection molded. That is, the terminal assembly 20 does not involve in-mold injection molding, which further reduces the manufacturing costs.

Most importantly, in the terminal assembly 20 of the embodiment, each of the components thereof is independent and the terminal assembly is easily assembled, which allows for standardization, enabling the terminal assembly to be universal when developing different product types. Different types of specifications of the cover plate 10 are then redeveloped to reduce redundancy across an entire industry, accelerating product development and lowering inventory costs.

### Embodiment 2

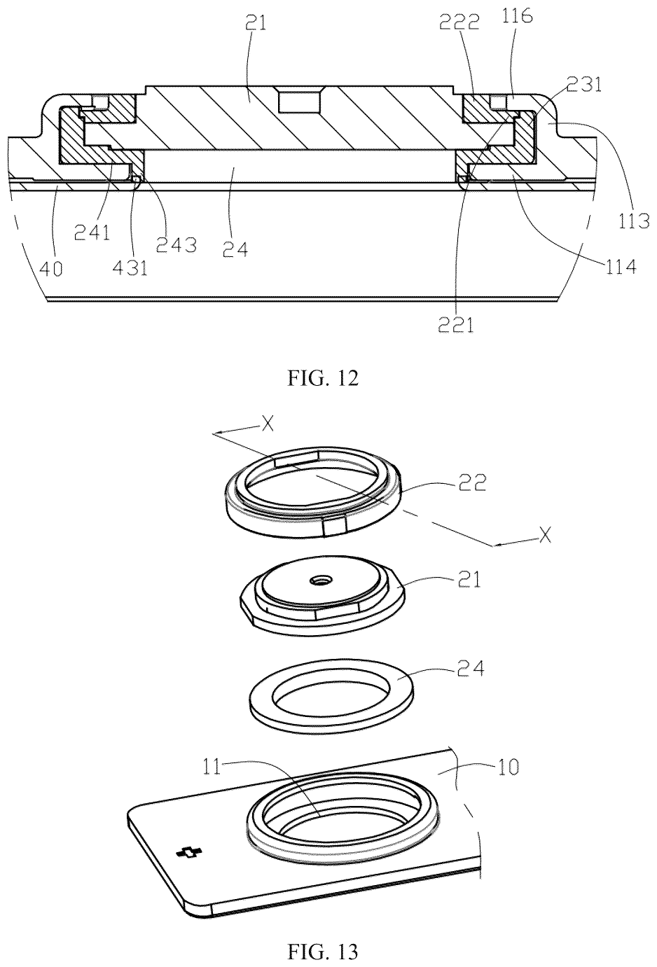

As shown in FIG. 12. Embodiment 2 is an alternative structure of the terminal assembly 20 compared to the terminal assembly 20 in Embodiment 1. A difference is that the lower shell 23 is eliminated, and the sealing piece 25 integrates functions of the original sealing piece 24 and the lower shell 23.

Specifically, structures of the terminal 21 and the upper shells do not change, while the sealing piece 25 comprises a covering body 211, an extension cylindrical portion 243, and a ring body 23. The covering body 211 covers the lower surface of the fixing ring 211 of the terminal 21. The extension cylindrical portion 243 extends downward from the inner edge of the covering body 241. The ring body 231 extends upward from the outer edge of the covering body 211 and covers the outer edge of the fixing ring 211. A top portion of the ring body 231 exceeds the upper surface of the fixing ring 211 but does not exceed the upper surface of the step portion 212.

During assembly, the sealing piece 25 wraps upwards around the terminal 21, and a thickness of the ring body 231 is greater than a distance between the fixing ring 211 of the terminal 21 and the sidewall 113 of the corresponding terminal hole 11 to achieve an interference fit seal after insertion. An inner edge of the ring body 231 extends toward a center thereof to form an extension rim covering a portion of the surface of the upper shell 22's covering body 221. During assembly, the upper shell 22 is first sleeved on the terminal 21, and then the sealing piece 25 is wrapped around the terminal 21 from bottom to top, covering a portion of the surface of the upper shell 22 for pre-fixation.

The engaging groove 215 on the lower surface of the terminal 21 and the limiting raised rim 242 on the outer edge of the covering body 241 of the sealing piece 25 are still provided to prevent the sealing piece 25 from collapsing or shifting during compression. The upper shell 22 is made of the conductive plastic material as that in Embodiment 1.

Compared to Embodiment 1, Embodiment 2 eliminates the lower shell 23, resulting in a simpler structure. However, an outer periphery of the fixing ring 211 of the terminal 21 lacks support from a rigid structure, which may lead to a slight risk of displacement of the terminal 21.

### Embodiment 3

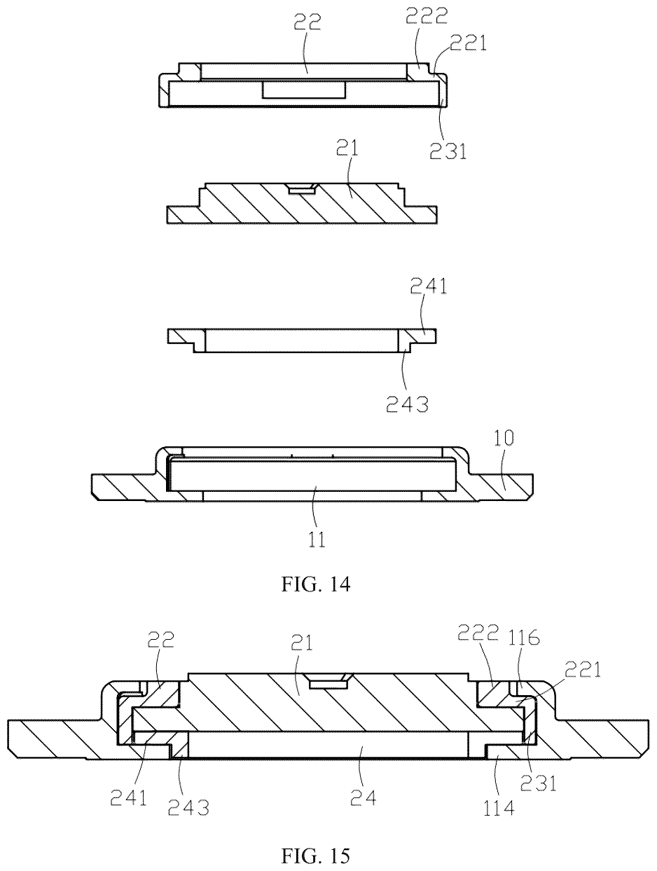

FIGS. 13-15 are the accompanying drawings for the terminal assembly 20 and the battery top cover of Embodiment 3 of the present disclosure. A structural principle of Embodiment 3 is described in detail below.

Embodiment 3 is an alternative technical solution of the terminal assembly 20 of Embodiment 1. A difference is that some functional structures of the lower shell 23 are integrated onto the upper shell 22, making the upper shell 22 and the lower shell 23 form an integral structure. Because the integral structure is sleeved on the terminal 21, the integral structure is defined as the upper shell 22 in the embodiment.

Specifically, the upper shell 22 of the terminal assembly 20 in the embodiment comprises the covering body 221 covering the upper surface of the fixing ring 211 of the terminal 21, the isolation protrusion 222 extending upward from the inner edge of the covering body 221, and the ring body 231 extending downward from the outer edge of the covering body 221. The ring body 231 further wraps around the outer surface of the fixing ring 211. The ring body 231 exceeds downward to exceed the lower surface of the fixing ring 211. The outer edge of the clamping ring 241 of the sealing piece 24 is disposed within the ring body 231.

In the embodiment, the engaging groove 215 at the bottom portion of the terminal 21 and the limiting raised rim 242 may still be provided to limit the position of the sealing piece 24 and prevent inward collapse after compression.

Compared to Embodiment 1, the embodiment eliminates the lower shell 23 and integrates functions of the lower shell 23 into the upper shell 22, resulting in a simpler structure. During assembly, the terminal 21 is first pressed into the upper shell 22 in an interference fit manner, and then the sealing piece 24 is installed into the ring body 231 of the upper shell 22 and attached to the bottom surface of the fixing ring 211 of the terminal 21. A disadvantage is that more conductive plastic material is used to make the terminal assembly, which increases the material costs. Similarly, terminal assembly in the embodiment may be promoted as an industry standard, making the terminal assembly universal.

In the embodiment, the at least one anti-rotation mating surface 223 is still formed on inner surfaces of the ring body 231, the covering body 221, and the isolation protrusion 222 of the upper shell 22 to cooperate with the at least one anti-rotation flat surface 214 on the terminal 21, so as to prevent rotation between the upper shell 22 and the terminal 21. The at least one anti-rotation block 232 is still disposed on the ring body 231 to cooperate with the anti-rotation groove 115 in the corresponding terminal hole 11 to prevent the terminal assembly 20 from rotating in the corresponding terminal hole 11.

### Embodiment 4

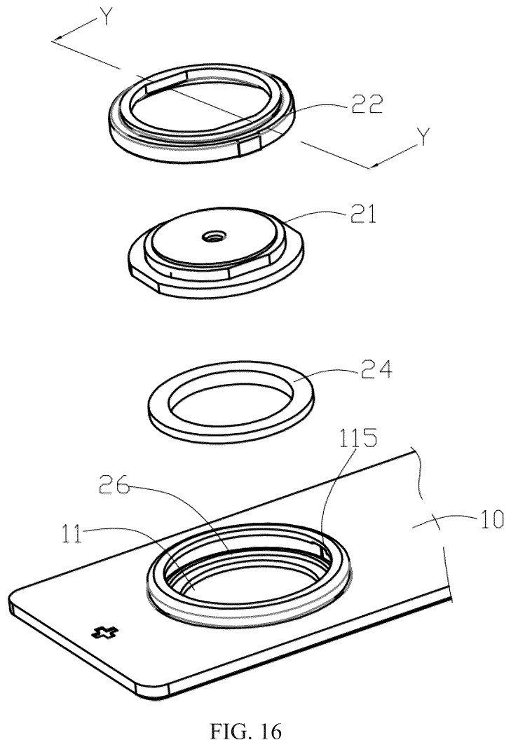

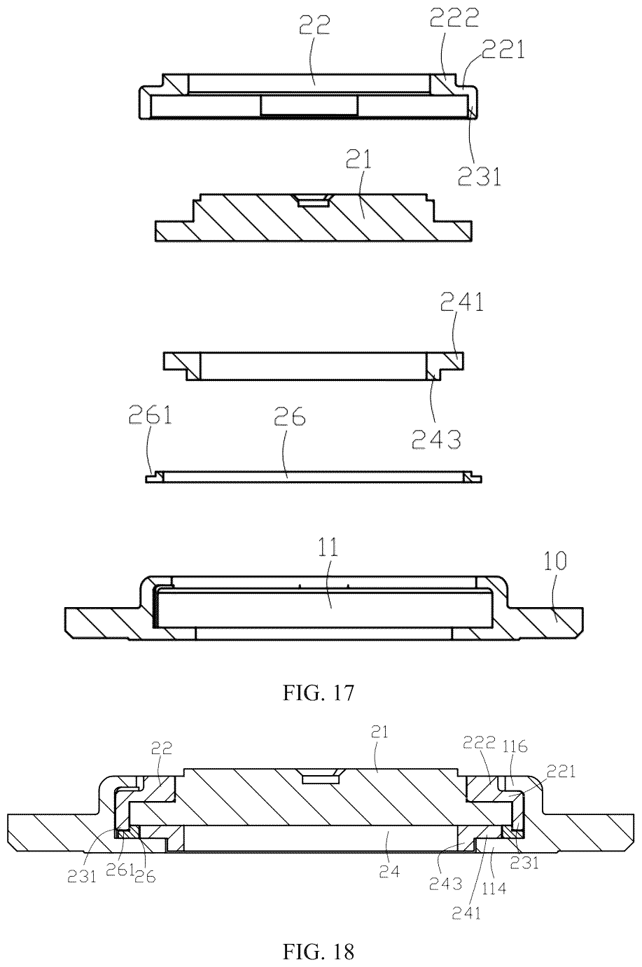

FIGS. 16-18 are accompanying drawings for the terminal assembly 20 and the battery top cover of Embodiment 4 of the present disclosure. A structural principle of Embodiment 4 is described in detail below.

Embodiment 4 is an improvement and optimization of a technical solution of Embodiment 3. A difference lies in an addition of a gasket 26. An outer edge of the gasket 26 is recessed to form a receiving groove 261. A bottom portion of the ring body 231 of the upper shell 22 is accommodated in the receiving groove 261. A downward extension length of the ring body 231 is correspondingly shortened, and a bottom edge of the fixing ring 211 of the terminal 21 is pressed against an upper surface of the gasket 26.

When the gasket 26 rivets the flange 116 of the corresponding terminal hole 11 and presses the upper shell 22 downward, the gasket 26 prevents the ring body 231 of the upper shell 22 from collapsing inward and pressing against the sealing piece 24, thus preventing the sealing piece 24 from shifting.

As shown in FIGS. 10 and 11, the terminal assembly 20 described in Embodiments 1 to 4 is ultimately inserted into the corresponding terminal hole 11 of the cover plate 10. The sealing piece 24 is clamped between the fixing ring of the terminal 21 and the bottom wall 114 of the corresponding terminal hole 11. The extension cylindrical portion 243 extends downward onto the inner surface of the punched hole 112 at the bottom wall 114 of the corresponding terminal hole 11. The extension cylindrical portion 243 then abuts against the annular boss 431 of a corresponding connecting hole 43 of the insulating plate 40. The annular boss 431 supports the sealing piece 24, preventing the sealing piece 24 from being compressed and deformed downwards. In one embodiment, the annular boss 431 is designed to be inclined toward a center thereof, so that the extension cylindrical portion 243 of the sealing piece 24 is located between the annular boss 431 and the inner surface of the punched hole 112 of the corresponding terminal hole 11.

Subsequently, the top portion of the sidewall 113 of the corresponding terminal hole 11 is riveted towards the center to form the flange 116 that presses downwards against the covering body 221 of the upper shell 22, thus sealing the clamping body 241 of the sealing piece 24 disposed between the fixing ring 211 and the bottom wall 114. In a vertical projection direction, the outer edge of the fixing ring 211 at least partially overlaps with the flange 116. Surfaces of the flange 116, the isolation protrusion 222, and the step portion 212 are flush.

In Embodiments 1 and 2, after the terminal assembly 20 is inserted into the corresponding terminal hole 11 and riveted, the limiting raised rim 242 of the sealing piece 24 is radially limited outward by the engaging groove 215 at the bottom portion of the fixing ring 211, preventing the sealing piece 24 from collapsing toward the center.

It should be noted that the terminal assembly 20 of Embodiments 1-4 is allowed to be applied to the cover plate 10 using a welding ring, as can the terminal assembly 20 in the applicant's previous patent application No. CN202110666517.4. In this way, the versatility of the terminal assembly 20 improves and makes it a universal standard.

The battery cover plate of the present disclosure is applied to a power battery. The power battery comprises a battery casing, a cell encapsulated within the battery casing, the battery cover plate enclosing the cell within the battery casing, and conductive sheets connecting terminals 21 to the cell. Specifically, each of the conductive sheets is welded to the lower surface of the middle portion of the fixing ring 211 of the terminal 21 of a corresponding terminal assembly 20 through a corresponding connecting hole 43 of the insulating plate 40 disposed under the battery cover plate.

The terminal assemblies 20 in the embodiments are cylindrical. In other embodiments, the terminal assemblies 20 are square, which are still within the protection scope of the present disclosure.

### Embodiment 5

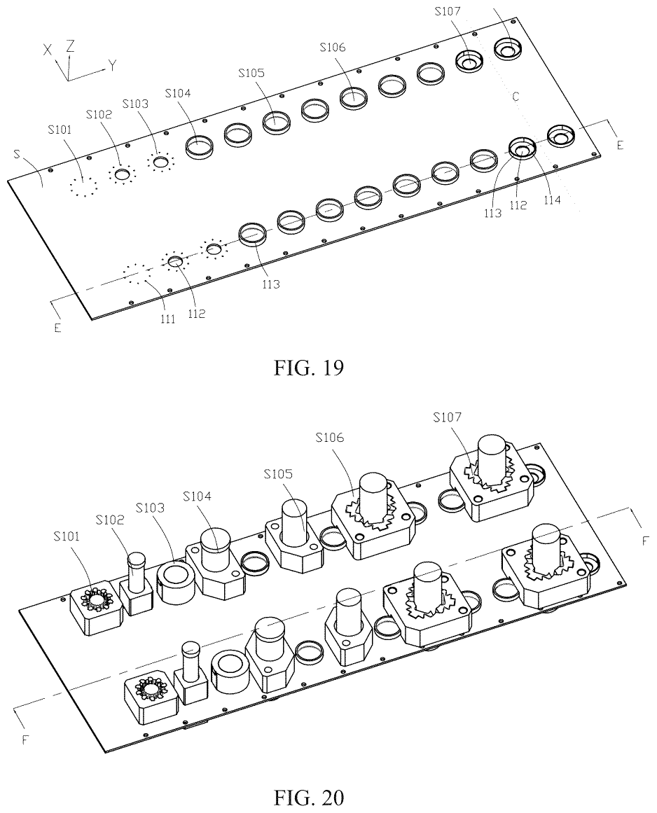

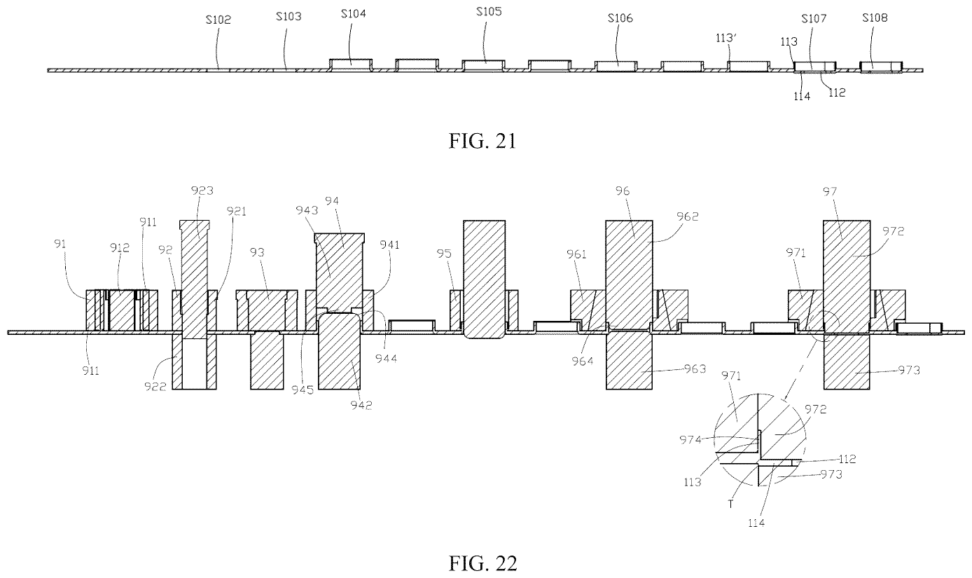

As shown in FIGS. 19-23. Embodiment 5 mainly introduces a processing process of the terminal holes 11 of the cover plate 10.

In the present disclosure, as shown in FIG. 19, an X direction is defined as a horizontal direction, a Y direction is defined as a vertical direction, and a Z direction is defined as a direction (top) perpendicular to the X direction and the Y direction.

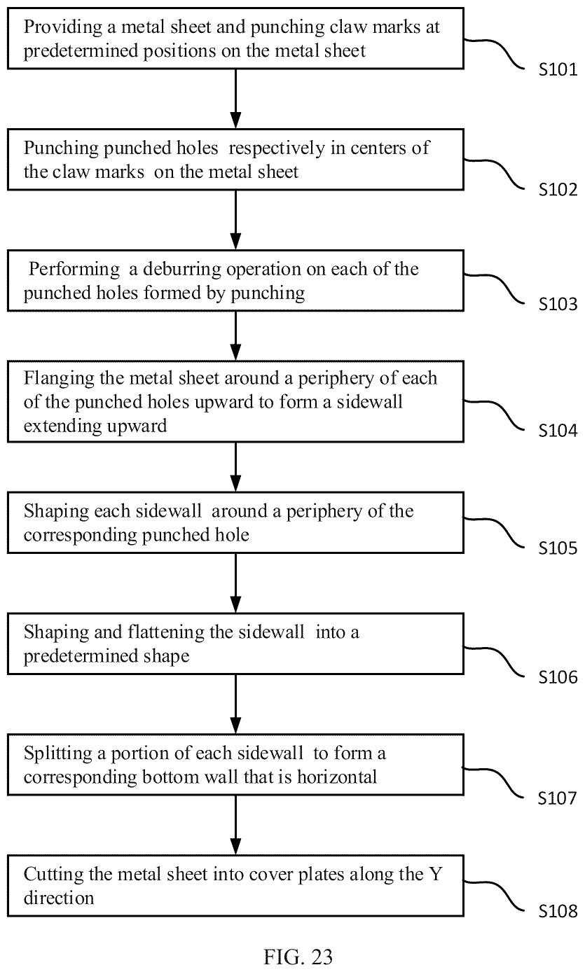

As shown in FIG. 23, a cover plate manufacturing method in the embodiment mainly comprises steps S101-S108.

Step S101 comprises providing a metal sheet S and punching claw marks at predetermined positions on the metal sheet S. Each of the claw marks is annular.

The step is optional. In different implementations, the claw marks on the step may not be provided. The claw marks 111 serve to increase a bonding force with molded plastic in some in-mold injection molding processes.

The claw marks 111 are stamped on two sides of the metal sheet S along the Y direction, corresponding to positive terminals and negative terminals of terminal holes 11. In some embodiments, such as blade batteries, it is only necessary to form one row of claw marks 11 in the Y direction of the metal sheet S.

In the step, punching dies 91 are applied. Each of the punching dies 91 comprises a positioning die 911 and a punching punch 912, where the positioning die 911 is cylindrical and is configured to extrude a surface of the metal sheet S, the positioning die 911 comprises holes disposed in a circle array, and the punching punch 912 is formed in the positioning die 911 and surrounded by the holes. Each punching punch 912 is configured to punch downwards onto the metal sheet S to form a corresponding claw mark. Specifically, the holes are disposed on a periphery of each positioning die 911, and each punching punch 912 punches downwards within the holes to form the corresponding claw mark.

Step S102 comprises punching punched holes 112 respectively in centers of the claw marks 111 on the metal sheet S.

In the step, punching dies 92 are configured to stamp punched holes 112 in the centers of the claw marks 111. Each of the punched holes 112 shares the same center as a corresponding claw mark 111, and there is a certain distance between an edge of each of the punched holes 112 and a location of the corresponding claw mark 111.

Each of the punching dies 92 comprises a lower fixing sleeve 922, an upper fixing sleeve 921, and a hole punch 923. Each lower fixing sleeve 922 is hollow and supports a lower surface of the metal sheet S. Each upper fixing sleeve 921 corresponds to a corresponding lower fixing sleeve 922, is hollow, and is configured to extrude an upper surface of the metal sheet S. Each hole punch 923 is sleeved inside a corresponding upper fixing sleeve 921. Each hole punch 923 strikes downward to cut off a portion of the metal sheet S at a corresponding predetermined position and forms a corresponding punched hole 112.

Step S103 comprises performing a deburring operation on each of the punched holes formed by punching.

The step is mainly intended to remove burrs formed during a punching process of the step S102. The step is optional and may be omitted depending on product quality requirements, improvements in punching processes, and other factors. In the step, deburring dies 93 are configured to remove the burrs and other materials to prevent potential issues such as short circuits.

Step S104 comprises flanging the metal sheet S around a periphery of each of the punched holes 112 upward to form a sidewall 113 extending upward.

In the step, an amount of flanging is determined by product dimensions. A flanging operation is performed by flanging dies 94. Specifically, each of the flanging dies 94 comprises a hollow upper die sleeve 941, a positioning head 943 sleeved in the hollow upper die sleeve 941, and a flanging punch 942. Each flanging punch 942 is configured to bend a periphery of a corresponding punched hole 112 upward from an underside of the metal sheet S. A head 945 is protruded downward from a central portion of a bottom surface of each positioning head 943. Each head 945 is extendable into a corresponding punched hole 112. Each head 945 is configured to protect an edge of the corresponding punched hole 112. A top edge of each flanging punch 942 is arc-shaped to prevent damage to the metal sheet S during upward flanging.

During the flanging operation, the head 945 of each positioning head 943 is inserted downward into the corresponding punched hole 112 to protect the edge of the corresponding punched hole 112, while each flanging punch 942 extrudes the metal sheet S upwards. Each flanging punch 942 and the corresponding punched hole 112 are concentric. There is a gap between an outer surface of the flanging punch 942 and an inner wall of the upper die sleeve 941 of each of the flanging dies 94 to accommodate a corresponding sidewall 113 extending upward. For each of the flanging dies 94, when the flanging punch 942 moves upward, the flanging punch 942 first contacts the head 945 of the positioning head 943 and pushes the positioning head 943 upward, then, the flanging punch 942 begins to extrude the metal sheet S upward until the metal sheet S around the corresponding punched hole 112 is extruded upward to form the corresponding sidewall 113. At this time, each sidewall 113 has a certain tilt angle. Specifically, each sidewall 113 is tilted at a small angle towards a center of a corresponding punched hole.

Step S105 comprises shaping each sidewall 113 around a periphery of the corresponding punched hole 112.

The step is performed to shape each sidewall 113 to bring each sidewall 113 into a vertical state. The step is primarily performed by shaping dies 95. Each of the shaping dies 95 has a positioning sleeve (not labeled) surrounding outside a corresponding sidewall 113 to limit an outer position of the corresponding sidewall 113. Then, a shaping head (not labeled) of each shaping dies 95 is inserted from the corresponding sidewall 113 and extrudes the corresponding sidewall 113 outward to shape the corresponding sidewall 113 into a vertical state at a 90-degree position.

Step S106 comprises shaping and flattening the sidewall 113 to bring it into a predetermined shape.

In the step, a flatness of a top surface and a thickness at various positions of each sidewall 113 are shaped. So that each sidewall 113 is shaped to a predetermined shape. Specifically, the step is performed by flattening dies 96. Each of the flattening dies 96 comprises an upper die base 961, a flattening punch 962 inserted into the upper die base 961, and a lower support die 963. Each upper die base 961 is hollow. A central portion of a bottom surface of each flattening punch 962 protrudes downward to form a punch extruding portion 964. A gap for accommodating a corresponding sidewall 113 is formed between an outer periphery of the punch extruding portion 964 and an inner surface of the upper die base 961 of each of the flattening dies. A height of each gap corresponds to a predetermined height of the corresponding sidewall 113.

During flattening, each sidewall 113 undergoes metal flow and is made uniform through downward extruding by a corresponding flattening punch 962, ensuring a consistent height at all positions.

Step S107 comprises splitting a portion of each sidewall 113 to form a corresponding bottom wall 114 that is horizontal.

In the step, a portion of an inner wall of each sidewall is extruded downward to form the corresponding bottom wall 114. After completing the step, a thickness of each sidewall 113 is reduced by more than half, meaning that over half of the material forming the inner wall of each sidewall 113 is extruded into the corresponding bottom wall 114. Further, a thickness of each bottom wall 114 is greater than the thickness of each sidewall 113.

The step is performed by material splitting dies 97. Each of the material splitting dies 97 comprises an upper die base 971, a lower die base 973, and a material splitting punch 972 sleeved in the upper die base 971. Each upper die base is hollow. A central portion of a top surface of each lower die base 973 is recessed downward to a certain extent to form a recess. Each recess is disposed outside a material splitting position of a corresponding sidewall 113 but does not exceed an outer surface of the corresponding sidewall 113, which causes the corresponding bottom wall 114 to protrude slightly downward, forming a protruding surface T. An inner groove 974 is defined on a lower outer edge of each material splitting punch 972. For each of the material splitting dies 97, a distance between the inner groove 974 and an inner surface of the upper die base 971 corresponds to the thickness of each sidewall 113 after material splitting.

In another embodiment, each of the material splitting dies 97 of the present disclosure is improved to simultaneously form a corresponding punched hole 112 during material splitting. In the case, based on an inner diameter of each punched hole 112, a mating hole and a column structure matched with the mating hole are respectively disposed on the lower die base 973 and a bottom surface of the material splitting punch 972 of each of the material splitting dies 97 to limit a downward-extruded metal material around a periphery of the column structure. Each column structure has a slope for being easily inserted into the mating hole. Optionally, the column structure is disposed on the bottom surface of each material splitting punch 972, and the mating hole is disposed within each lower die base 973. Of course, positions of each column structure and each mating hole may be swapped. By controlling a material splitting thickness, the corresponding bottom wall 114 and the corresponding punched hole 112 are formed in a single punching operation.

Step S108 comprises cutting the metal sheet S into cover plates along the Y direction.

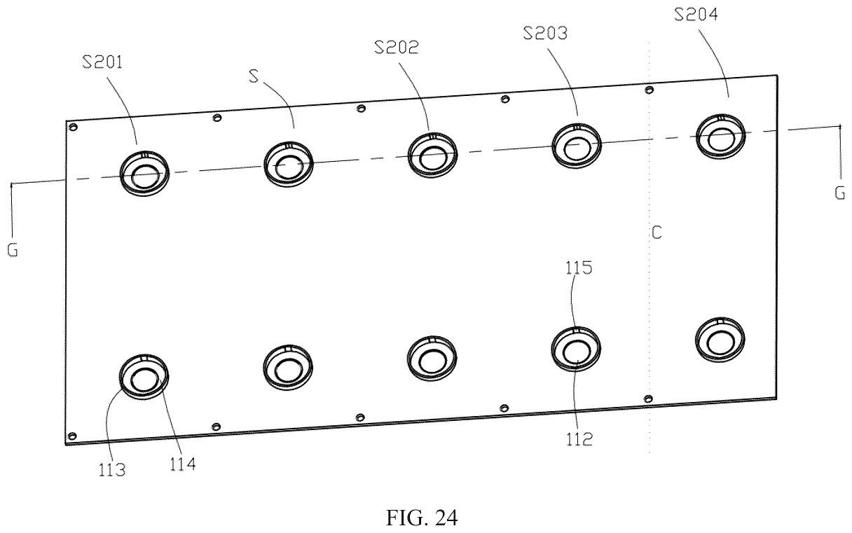

The step comprises cutting the terminal holes 11 that are continuously stamped on the metal sheet S into the cover plates. In the embodiment, each of the cover plates (i.e., each cover plate 10) comprises two terminal holes 11 disposed along the X direction. That is, the metal sheet S is cut into cover plates 10 along a dashed line C shown in FIG. 24.

In Embodiment 5, the terminal holes 11 of each of the cover plates 10 are formed through punching, and then each of the terminal assemblies 20 is fixed by integrally riveting and bending each sidewall 113, which eliminates a need in the prior art to form welding rings for fixing the terminal assemblies 20, thereby greatly reducing costs while offering a simple structure and easy assembly.

### Embodiment 6

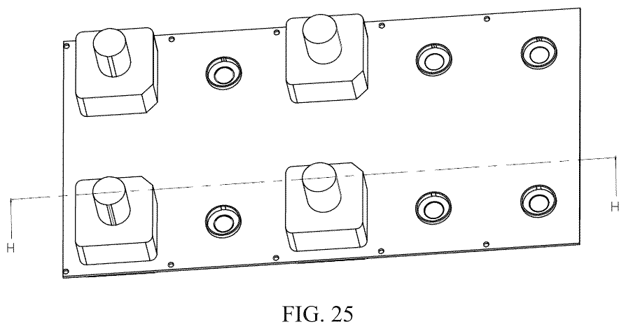

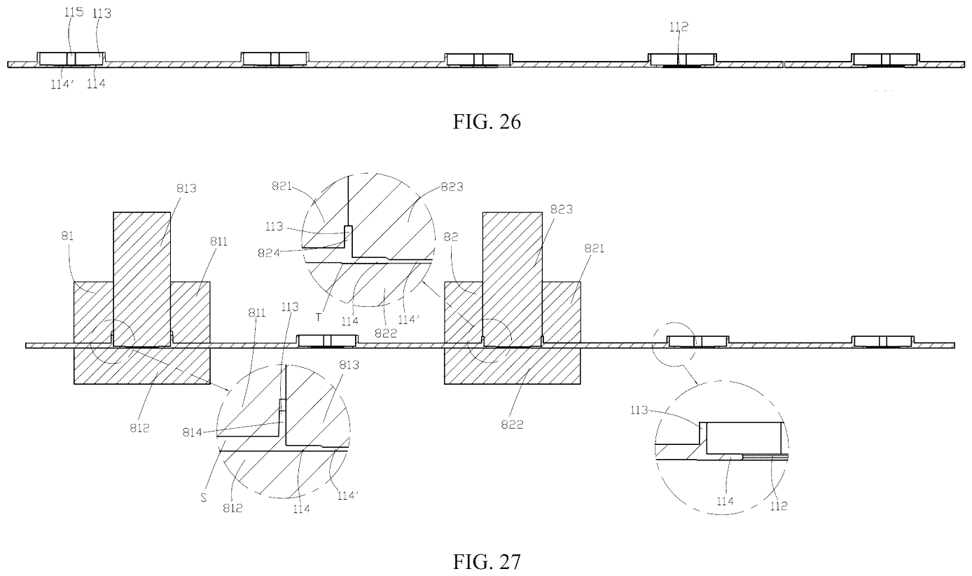

As shown in FIGS. 24-28. Embodiment 6 introduces a processing process of the terminal holes 11 of the cover plate 10.

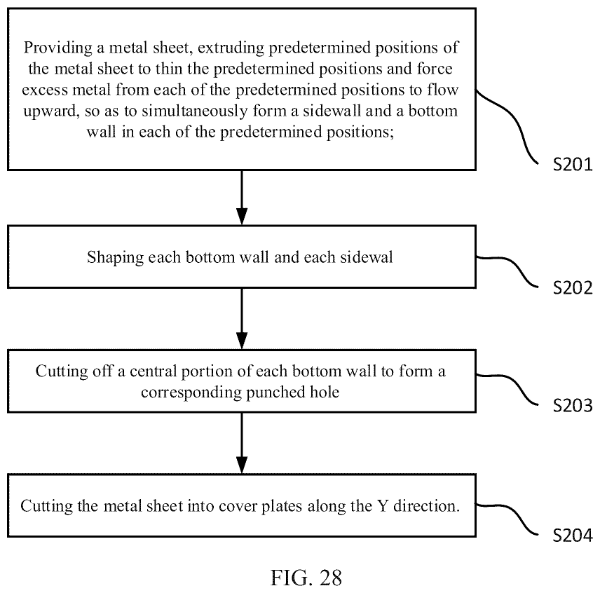

As shown in FIG. 28, a cover plate manufacturing method in the embodiment mainly comprises steps S201-S204.

Step S201 comprises providing a metal sheet S and extruding predetermined positions of the metal sheet S to thin the predetermined positions and force excess metal from each of the predetermined positions to flow upward, thereby simultaneously forming a sidewall 113 and a bottom wall 114 in each of the predetermined positions.

In the step, the operation is implemented by extruding dies 81. Specifically, each of the extruding dies 81 comprises a lower die seat 812 with a flat surface, an upper die seat 811, and an extruding punch 813 inserted into the upper die seat 811.

Each lower die seat 812 supports a bottom surface of the metal sheet S at a corresponding predetermined position. Each upper die seat 811 is hollow and presses against an upper surface of the metal sheet S at a corresponding predetermined position. A lower side of a hollow cavity of each upper die seat 811 is recessed radially outward to form a material splitting groove 814. A height of each material splitting groove 814 is greater than a required height of each sidewall 113. A central portion of each extruding punch 813 protrudes downward, and an outer diameter of a protruding portion thereof is not greater than an inner diameter of each punched hole 112.

In the step, a wall thickness of each sidewall 113 in a vertical direction may not be uniform and maybe designed to be thicker at a bottom portion thereof and thinner at a top portion thereof.

In another embodiment, each material splitting groove 814 is disposed on a lower outer periphery of each extruding punch 813, while an inner surface of each upper die seat 811 remains flat. Alternatively, each material splitting groove 814 is formed by recessing both the upper die seat 811 and the extruding punch 813 of each of the extruding dies.

During an extruding process of the step, the protruding portion of each extruding punch 813 first extrudes downward on the corresponding predetermined position of the metal sheet S, causing the metal at the corresponding predetermined position to flow radially outward, thereby thinning the corresponding predetermined position. The protruding portion of each extruding punch 813 continues to extrude downward, so that the lower surface of the extruding punch 813 fully extrudes the metal sheet S at the corresponding predetermined position. At this point, the metal at the corresponding predetermined position flows radially outward and ultimately grows along a corresponding material splitting groove 814 to simultaneously form the corresponding sidewall 113 and the corresponding bottom wall 114. A central portion of each bottom wall 114, corresponding to the protruding portion of each extruding punch 813, forms a bottom wall intermediate portion 114. Each bottom wall intermediate portion 114 is thinner than each bottom wall 114.

Step S202 comprises shaping each bottom wall 114 and each sidewall 113.

In the step, irregular portions of each bottom wall 114 and each sidewall 113 are shaped to achieve predetermined thickness and shape.

The step is performed by shaping dies 82. Each of the shaping dies 82 comprises a lower seat 822, an upper sleeve 821, and a shaping punch 823 inserted into the upper sleeve 821. Similar to the extruding dies 81, in each of the shaping dies 82, the upper sleeve 821 and the shaping punch 823 jointly define a shaping groove 824 at a position corresponding to a corresponding sidewall 113. In each of the shaping dies 82, the shaping groove 824 is formed by recessing an inner surface of a hollow cavity of the upper sleeve 821 outward and recessing an outer surface of the shaping punch 823 inward. The configurations prevent each shaping punch 823 from redistributing material on the corresponding sidewall 113 again when each shaping punch 823 extrudes downward for shaping. A thicker bottom and thinner top design of each sidewall 113 in the step S201 also reduces the risk. A central portion of a bottom surface of each shaping punch 823 similarly protrudes downward to form a protruding portion, further bringing the thickness of each bottom wall 114 to the predetermined thickness and ensuring a flatness of each bottom wall 114. A height of each shaping groove 824 is the same as a predetermined height of each sidewall 113. After the step, the surface of each sidewall 113 is smooth, and the thickness thereof is uniform.

A recessed space is formed in a central portion of each lower seat 822 corresponding to the corresponding sidewall 113, causing each bottom wall 114 to protrude slightly downward and form a protruding surface T.

Step S203 comprises cutting off a central portion of each bottom wall 114 to form a corresponding punched hole 112.

The step is achieved using simple punching dies, which are not shown in the drawings. Specifically, each bottom wall intermediate portion 114′ is cut away to form the corresponding punched hole 112.

Step S204 comprises cutting the metal sheet S into cover plates along the Y direction.

The step comprises cutting the terminal holes 11 that are continuously stamped on the metal sheet S into the cover plates. In the embodiment, each of the cover plates (i.e., each cover plate 10) comprises two terminal holes 11 disposed along the X direction. That is, the metal sheet S is cut into cover plates 10 along a dashed line C shown in FIG. 27. The cutting equipment is relatively simple and is not shown in the drawings. The step may be integrated with the aforementioned process flow in a continuous punching device, completed through continuous operation. Each punching operation is able to complete one complete manufacturing method, effectively improving punching efficiency.

In Embodiment 6, the terminal holes 11 of each of the cover plates 10 are formed through punching, and then each of the terminal assemblies 20 is fixed by integrally riveting and bending each sidewall 113, which eliminates a need in the prior art to form welding rings for fixing the terminal assemblies 20, thereby greatly reducing costs while offering a simple structure and easy assembly. Compared to the manufacturing method in Embodiment 5, the steps in the embodiment are simpler and punching equipment is more concise, which effectively improves efficiency and reduces costs.

What is claimed is:

1. A cover plate manufacturing method, comprising following steps:
S101: providing a metal sheet, and punching the metal sheet to form punched holes;
S102: flanging a portion of the metal sheet on a periphery of each of the punched holes to form a sidewall extending upward;
S103: shaping and flattening each sidewall to enable each sidewall to reach a predetermined state; and
S104: splitting a material of each sidewall to form a horizontal bottom wall and form cover plates with terminal holes;
wherein the material forming an inner wall of each sidewall is extruded in a thickness direction to form the horizontal bottom wall.

2. The cover plate manufacturing method according to claim 1, wherein between the step S101 and the step S102, the cover plate manufacturing method further comprises a step of removing burrs in the punched holes.

3. The cover plate manufacturing method according to claim 1, wherein in the step S102, a flanging die is provided to form each sidewall;
wherein the flanging die comprises an upper die sleeve, a positioning head sleeved in the upper die sleeve, and a flanging punch;
wherein the flanging punch is configured to bend the periphery of a corresponding punched holes upward from an underside of the metal sheet;
wherein the upper die sleeve is hollow, a head is protruded downward from a central portion of a bottom surface of the positioning head, the head is extendable into a corresponding punched hole, and a top edge of the flanging punch is arc-shaped.

4. The cover plate manufacturing method according to claim 3, wherein the head is configured to insert into the corresponding punched hole to protect an edge of the corresponding punched hole, the flanging punch is configured to move upward to extrude the metal sheet, the flanging punch is coaxial with the corresponding punched hole, and a gap is defined between an outer surface of the flanging punch and an inner surface of the upper die sleeve to accommodate a corresponding sidewall;
wherein when the flanging punch moves upward, the flanging punch first contacts the head of the positioning head and pushes the positioning head upward, then extrudes the metal sheet upward until a portion of the metal sheet around the flanging punch extrudes the periphery of the corresponding punched hole upward to form the corresponding sidewall;
wherein in the step S102, each sidewall is inclined inward.

5. The cover plate manufacturing method according to claim 4, wherein between the steps S102 and S103, the cover plate manufacturing method further comprises a step of shaping each sidewall, so that each sidewall is changed from an inclined state to a vertical state;
wherein the step of shaping each sidewall is performed by a shaping die, the shaping die comprises a positioning sleeve and a shaping head, the positioning sleeve is configured to surround a corresponding sidewall to limit an outer position of the corresponding sidewall, and the shaping head is configured to insert into a corresponding sidewall to extrude the corresponding sidewall outward to shape the corresponding sidewall into the vertical state;
wherein in the vertical state, each sidewall is perpendicular to a horizontal plane.

6. The cover plate manufacturing method according to claim 3, wherein the step S103 is performed by a flattening die, and the flattening die comprises an upper die base, a flattening punch inserted into the upper die base, and a lower support die;
wherein the upper die base is hollow, a central portion of a bottom surface of the flattening punch protrudes downward to form a punch extruding portion, and a gap for accommodating a corresponding sidewall is formed between an outer periphery of the punch extruding portion and an inner surface of the upper die base;
wherein a height of the gap is a predetermined height of each sidewall, and when the flattening punch extrudes downward, the corresponding sidewall undergoes metal flow and is rendered uniform, and the height of each sidewall is kept consistent.

7. The cover plate manufacturing method according to claim 1, wherein the step S104 is performed by a material splitting die;
wherein the material splitting die comprises an upper die base, a lower die base, and a material splitting punch inserted into the upper die base;
wherein a central portion of a top surface of the lower die base is recessed downward to form a recess, and the recess is located outside a material splitting position of a corresponding sidewall and does not exceed an outer surface of the corresponding sidewall;
wherein an inner groove is disposed on an outer edge of a lower edge of the material splitting punch, a distance between an inner groove and an inner surface of the upper die base is equal to a thickness of each sidewall after material splitting;
wherein after the step 104, over half of a metal material of each sidewall is extruded downward from an inner side of each sidewall to form a corresponding horizontal bottom wall.

8. The cover plate manufacturing method according to claim 7, wherein a matching hole and a column structure are respectively disposed on the lower die base and a bottom surface of the material splitting punch, so that a portion of the metal material is limited around an outer periphery of the column structure.

9. The cover plate manufacturing method according to claim 1, wherein after the step S104, the cover plate manufacturing method further comprises a step of cutting the metal sheet into the cover plates, wherein each of the cover plates comprises at least one of the terminal holes.

10. A cover plate manufacturing method, comprising following steps:
S201: providing a metal sheet, extruding predetermined positions of the metal sheet to thin the predetermined positions and force excess metal from each of the predetermined positions to flow upward, so as to simultaneously form a sidewall and a bottom wall in each of the predetermined positions;
S202: shaping each bottom wall and each sidewall; and
S203: cutting off a central portion of each bottom wall to form a punched hole and finally obtaining cover plates with terminal holes.

11. The cover plate manufacturing method according to claim 10, wherein in the step S201, the terminal holes are respectively defined within the predetermined positions, and each excess metal on an upper layer of the metal plate flows to form a corresponding sidewall.

12. The cover plate manufacturing method according to claim 11, wherein the step S201 is performed by extruding dies, and each of the extruding dies comprises a lower die seat with a flat surface, an upper die seat, and an extruding punch inserted into the upper die seat;
wherein each lower die seat is configured to support a bottom surface of the metal sheet at a corresponding predetermined position, and each upper die seat is hollow and is configured to extrude an upper surface of the metal sheet at a corresponding predetermined position;
wherein a lower side of a hollow cavity of each upper die seat 811 is recessed radially outward to form a material splitting groove, a height of each material splitting groove is greater than a required height of each sidewall, a central portion of each extruding punch protrudes downward, and an outer diameter of a protruding portion of each extruding punch is not greater than an inner diameter of each punched hole.

13. The cover plate manufacturing method according to claim 12, wherein in the step S201, a wall thickness of each sidewall is thicker at a bottom portion thereof and thinner at a top portion thereof;
wherein during an extruding process of the step S201, the protruding portion of each extruding punch first extrudes downward on the corresponding predetermined position of the metal sheet, causing the excess metal at the corresponding predetermined position to flow radially outward to thin the corresponding predetermined position, the protruding portion of each extruding punch continues to extrude downward, so that a lower surface of each extruding punch fully extrudes the metal sheet at the corresponding predetermined position, and the excess metal at the corresponding predetermined position flows radially outward along a corresponding material splitting groove to simultaneously form the corresponding sidewall and the corresponding bottom wall;
wherein a central portion of each bottom wall, corresponding to the protruding portion of each extruding punch, forms a bottom wall intermediate portion, and each bottom wall intermediate portion is thinner than each bottom wall.

14. The cover plate manufacturing method according to claim 13, wherein the step S202 is performed by shaping dies, each of the shaping dies comprises a lower seat, an upper sleeve, and a shaping punch inserted into the upper sleeve;
in each of the shaping dies, the upper sleeve and the shaping punch jointly define a shaping groove at a position corresponding to a corresponding sidewall;
wherein in each of the shaping dies, the shaping groove is formed by recessing an inner surface of a hollow cavity of the upper sleeve outward and recessing an outer surface of the shaping punch inward;
wherein a height of each shaping groove is equal to a predetermined height of each sidewall, and after the step S202, an inner surface of each sidewall is smooth, and the wall thickness of each sidewall is uniform.

15. The cover plate manufacturing method according to claim 14, wherein a recessed space is formed in a central portion of each lower seat corresponding to a corresponding sidewall, so that each bottom wall protrudes slightly downward and forms a protruding surface after the step S202.

16. The cover plate manufacturing method according to claim 14, wherein in the step S203, the central portion of each bottom wall that is cut off is the bottom wall intermediate portion.

17. The cover plate manufacturing method according to claim 10, wherein after the step S203, the cover plate manufacturing method further comprises a step of cutting the metal sheet into the cover plates, wherein each of the cover plates comprises at least one of the terminal holes.

18. A battery top cover, comprising:
a cover plate formed by cover plate manufacturing method according to claim 1; and
at least one terminal assembly fixed in the cover plate;
wherein the at least one terminal assembly comprises a terminal, an upper shell covering an upper surface of the terminal, and a sealing piece attached to a lower surface of the terminal;
wherein the sealing piece is clamped between the bottom wall of at least one terminal hole and the lower surface of the terminal, and the sidewall of the at least one terminal hole is bent inward to press against the upper shell, so as to apply a downward pressure to deform the sealing piece for sealing a battery.

19. The battery top cover according to claim 18, wherein the upper shell is made of a conductive plastic material, and a resistance of the conductive plastic is 1-10,000 ohms.

20. The battery top cover according to claim 19, wherein the terminal comprises a fixing ring, a connecting portion protruding upward from a middle portion of the fixing ring, and a step portion formed between the connecting portion and the fixing ring;
wherein an outer diameter of the step portion is greater than an outer diameter of the connecting portion and is less than an outer diameter of the fixing ring, the at least one terminal assembly further comprises a lower shell, the lower shell covers an outer side of the fixing ring, and the lower shell is made of an insulating plastic material and comprises a ring body and a limiting step protruding radially inward from an inner wall of the ring body;
wherein the upper shell comprises a covering body and an isolation protrusion extending upward from an inner edge of the covering body, the covering body covers an upper surface of the fixing ring, the isolation protrusion covers an outer side of the step portion and presses the fixing ring into the lower shell, and an outer edge of a lower surface of the fixing ring is limited by the limiting step;
wherein the upper shell is snapped downward into the lower shell to fix the terminal in the lower shell and the upper shell, and the connecting portion extends upward to exceed an upper surface of the covering body.
